(19) United States
(12) Patent Application Publication
(10) Pub. No.: US 2011/0150291 A1
(43) Pub. Date: Jun. 23, 2011

(54) METHOD AND APPARATUS FOR RECOGNIZING ID IN MOBILE TERMINAL HAVING A TOUCHSCREEN

(75) Inventor: Sun-Tae JUNG, Yongin-si (KR)

(73) Assignee: Samsung Electronics Co., Ltd.

(21) Appl. No.: 12/975,905

(22) Filed: Dec. 22, 2010

(30) Foreign Application Priority Data
Dec. 22, 2009 (KR) 10-2009-0129340

(51) Int. Cl. G06K 9/00; G06F 3/044

(52) U.S. Cl. 382/115; 345/174

(57) ABSTRACT

Disclosed is a method for recognizing an ID in a mobile terminal having a touchscreen, the method including activating the touchscreen of the mobile terminal and receiving selection of either an ID registration mode or an ID authentication mode from a user; extracting a first bioelectric signal which is caused by the touch of the user and is input from the touchscreen when the ID registration mode is selected; determining if data analysis on the extracted first bioelectric signal is valid; extracting a first specific waveform from the extracted first bioelectric signal when the data analysis on the extracted first bioelectric signal is valid; and registering the extracted first specific waveform as an ID of the user.

### PRIORITY

This application claims priority to an application entitled “Method and Apparatus for Recognizing ID in Mobile Terminal Having Touch Screen” filed in the Korean Intellectual Property Office on Dec. 22, 2009, and assigned Serial No. 10-2009-0129340, the entire disclosure of which is incorporated herein by reference.

### BACKGROUND OF THE INVENTION

1. Field of the Invention

The present invention relates generally to a mobile terminal having a touchscreen, and more particularly to a method and apparatus for registering a unique ID for the user of the mobile terminal and performing authentication of the ID through the use of a specific waveform of a bioelectric signal of the user, which is acquired by the touchscreen.

2. Description of the Related Art

Recently, research has been conducted on self-identification using biometrics in mobile devices.

A physiological detection method used in biometrics includes fingerprint recognition, face recognition, DNA, vein, iris recognition, and the like, wherein fingerprint recognition is the technology that detects the shape of a fingerprint through a small scanner included in an image sensor, and verifies an ID by analyzing the unique image.

Also, face recognition, DNA, vein, iris recognition, and the like are technologies that identify a user's unique characteristics and verify their ID. The conventional biometric technology using a physiological ID detection method, as described above, requires an additional sensing part, so that a separate mounting space is required in a device, such as a PC, a mobile terminal, and the like, thereby increasing the material cost and resulting in a limitation of design.

The convention physiological ID detection method, as described above, is not suitable for recently made mobile terminals having touchscreens, which provide a relatively large screen and simultaneously usually have a simple and slim design.

### SUMMARY OF THE INVENTION

Accordingly, the present invention has been made to solve the above-mentioned problems occurring in the prior art, and the present invention provides a method and apparatus for measuring a biological signal through the use of a touchscreen included in a mobile terminal, analyzing a unique waveform of the biological signal, and recognizing an ID of the corresponding user.

In accordance with an aspect of the present invention, there is provided a method for recognizing an ID in a mobile terminal having a touchscreen, the method including activating the touchscreen of the mobile terminal and receiving a selection of either an ID registration mode or an ID authentication mode from a user; extracting a first bioelectric signal which is caused by the touch of a user and is input from the touchscreen when the ID registration mode is selected; determining if data analysis on the extracted first bioelectric signal is valid; extracting a first specific waveform from the extracted first bioelectric signal when the data analysis on the extracted first bioelectric signal is valid as a result of the determination; and registering the extracted first specific waveform as an ID of the user.

In accordance with another aspect of the present invention, there is provided an apparatus for recognizing an ID in a mobile terminal having a touchscreen, the apparatus including a touchscreen for generating an interrupt caused by a touch of a user, the touchscreen including an Electrocardiogram (EKG) sensor to measure a bioelectric signal; and a controller for extracting a specific waveform from a bioelectric signal, which is caused by a user's touch and is input from the touchscreen, according to the bioelectric signal and a mode selection signal, and then either registering the extracted specific waveform as the user's ID, or comparing the extracted specific waveform with a pre-registered user ID and controlling the mobile terminal to release a lock mode of the mobile terminal when the extracted specific waveform is included within a preset similar range.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view of a screen illustrating the operation of a mobile terminal having a touchscreen, to which an ID recognition method, according to an embodiment of the present invention is applied;

FIG. 2 illustrates the detailed configuration of the touchscreen in the mobile terminal shown in FIG. 1;

FIG. 3 is a flowchart illustrating an ID registration method in the ID recognition method in a mobile terminal having a touchscreen, according to an embodiment of the present invention;

FIG. 4 is a flowchart illustrating an ID authentication method in the IC recognition method in a mobile terminal having a touchscreen, according to an embodiment of the present invention;

FIG. 5 is a block diagram illustrating the configuration of an ID recognition apparatus in a mobile terminal having a touchscreen, according to an embodiment of the present invention; and

FIG. 6 illustrates the waveform and interval of an EKG electric signal according to an embodiment of the present invention.

### DETAILED DESCRIPTION OF THE EMBODIMENTS OF THE PRESENT INVENTION

Hereinafter, embodiments of the present invention will be described with reference to the accompanying drawings. Descriptions of well-known functions and constructions are omitted for clarity and conciseness. It will be understood by those skilled in the art that various changes in form and detail may be made within the scope of the present invention.

The present invention provides a method and apparatus for allowing a mobile terminal having a touchscreen to measure a user's biological signal through the use of the touchscreen, to analyze the waveform of the measured biological signal, to store/register the analyzed waveform as a user's unique ID, and thereafter, to permit or decline the use of the mobile terminal depending on a result of the determination of whether the waveform of a user's biological signal is the same as that registered as an ID, thereby providing the technology that enables a stronger ID to be set through the use of a user's unique biological information signal.

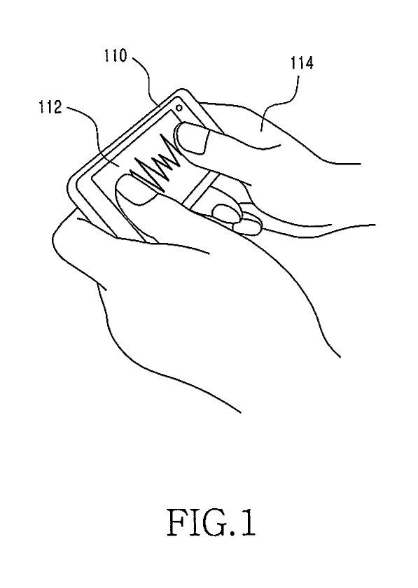

FIG. 1 is a view of a screen illustrating the operation of a mobile terminal having a touchscreen, to which an ID recognition method according to an embodiment of the present invention is applied.

As shown in FIG. 1, when a user who would like to register an ID touches a mobile terminal 110, to which the method of the present invention is applied, on a predetermined region of a touchscreen 112 by means of both his/her hands 114, a bioelectric signal caused by the user's touch is sensed through an electrocardiogram (EKG) sensor attached to touchscreen 112, the sensed bioelectric signal is displayed on touchscreen 112 while it is determined whether data analysis on the bioelectric signal is valid, a specific waveform is extracted from the bioelectric signal depending on a result of the determination, and then the extracted specific waveform is registered as an ID of the user.

Thereafter, in order to perform authentication of the user whose ID has been registered, a specific waveform is extracted from a bioelectric signal in the same manner as described above, the extracted specific waveform is compared with a pre-registered specific waveform, and the use lock mode of the mobile terminal is released when the extracted specific waveform is included within a preset similar range, so that authentication of the user whose ID has been registered in the mobile terminal is accomplished.

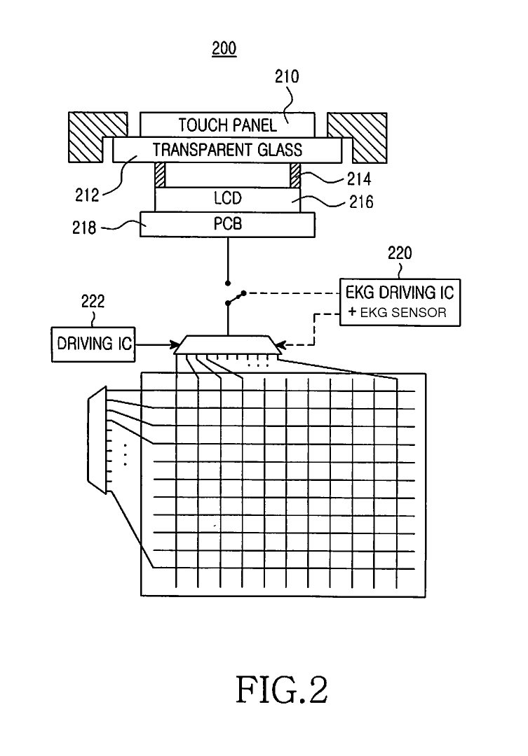

FIG. 2 illustrates the detailed configuration of a touchscreen in the mobile terminal shown in FIG. 1. Referring to FIG. 2, a touchscreen 200 includes a liquid crystal display (LCD) 216, a transparent glass plate 212 attached on top of the LCD 216 by means of a bonding member, a touch panel 210 installed on the upper surface of the transparent glass plate 212, and a Printed Circuit Board (PCB) 218. The PCB 218 includes a driving IC 222 which is printed on the PCB and is logically designed to supply power and driving signals to the LCD 216, and an EKG sensor and EKG sensor driving IC 220 for acquiring a bioelectric signal from the user. The above description has been given regarding the operation of a device, to which the ID recognition method in a mobile terminal having a touchscreen according to an embodiment of the present invention is applied. Hereinafter, the ID recognition method in a mobile terminal having a touchscreen according to an embodiment of the present invention will be described in detail.

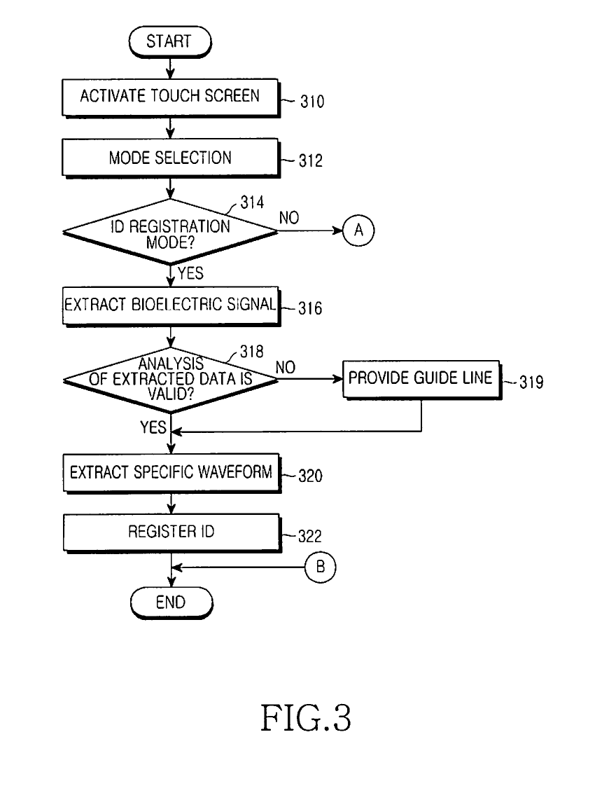

FIG. 3 is a flowchart illustrating an ID registration method in the IC recognition method in a mobile terminal having a touchscreen according to an embodiment of the present invention.

Referring to FIG. 3, first, in step 310, the user touches the surface of the touchscreen through the use of a user input means, such as a finger, a stylus pen, or the like, so as to generate a key touch interrupt, thereby activating the touchscreen of the mobile terminal, which has been in an idle mode.

In step 312, an ID registration mode or ID authentication mode is selected. A means for performing the mode selection, which is provided in the form of soft buttons on a general touchscreen, is separately displayed in a predetermined region of the touchscreen and is performed.

Accordingly, in step 312, the ID registration mode is selected when it is necessary to register a new user ID in order to begin initial use of the mobile terminal, at user change, and the like, and the ID authentication mode is selected when it is necessary to perform authentication with the pre-registered ID.

In step 314, it is checked whether a mode selected in step 312 is the ID registration mode, and the procedure proceeds to step 316 if the mode selected in step 312 is the ID registration mode.

In step 316, a bioelectric signal caused by the touch of the user, which is input from the touchscreen, is extracted.

Here, the bioelectric signal designates an electric signal of an Electrocardiogram (EKG) generated by the beating of a corresponding heart of a user, and the user touch input from the touchscreen is generated by the pressure of the both hands of the user, applied to a predetermined region of the touchscreen for a preset time period, wherein a pressure sensing value based on its operating scheme, i.e., based on a capacitance scheme according to an embodiment of the present invention, is output.

In this case, the waveform and interval of an EKG electric signal of the extracted bioelectric signal are shown as FIG. 6, and are the same as a bioelectric signal displayed on the touchscreen due to the touch of the user.

Thereafter, in step 318, it is determined whether data analysis on the bioelectric signal extracted in step 316 is valid. When it is determined that whether the data analysis on the extracted bioelectric signal is valid as a result of the determination, the procedure proceeds to step 320. In step 320, a specific part, i.e., a specific waveform, is extracted from the extracted bioelectric signal. The specific waveform is generated by an electrical potential difference of a bioelectric signal between both hands, and represents a waveform having a specific pattern, which is different depending on the user and is unique for each corresponding user.

Here, determining whether the data analysis is valid is performed in consideration of a recognition error rate and so on due to an incorrect touch of the user on the touchscreen. When the data analysis is not valid, the procedure proceeds to step 319, where a guide line, prompting the user to again touch the touchscreen is provided to the user. The guide line represents notifying the user of a correct touch method for the touchscreen so that the bioelectric signal of the user can be correctly extracted.

In step 320, the extracted specific waveform is registered as an ID of the user. In step 320, in order to perform analysis in order to authenticate the user and associate them to a corresponding ID, the extracted specific waveform may be registered together with an original signal, i.e., the bioelectric signal extracted when the touchscreen is touched.

In step 314, it is checked whether a mode selected in step 312 is the ID registration mode, and the procedure proceeds to step “A” when the mode selected in step 312 is not the ID registration mode.

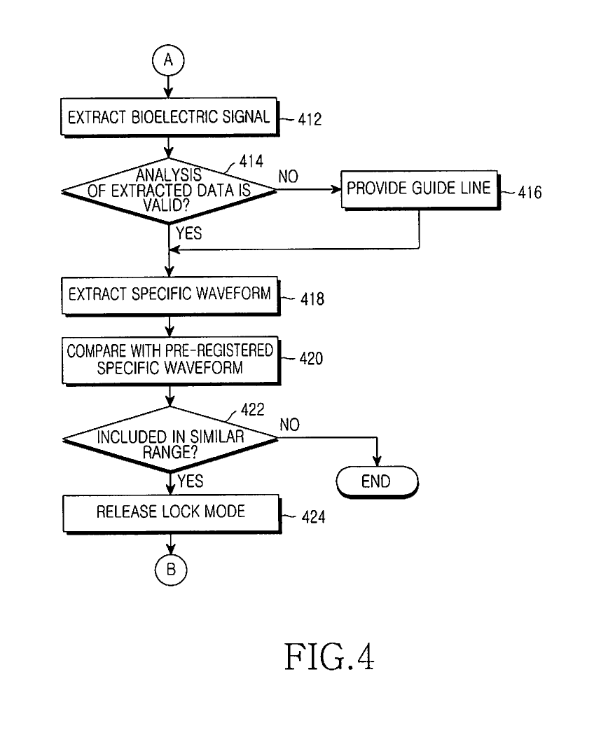

FIG. 4 is a flowchart illustrating an ID authentication method in the IC recognition method in a mobile terminal having a touchscreen according to an embodiment of the present invention.

First, in step 412, a bioelectric signal generated by a touch of a user, which is input from the touchscreen, is extracted.

In step 414, it is determined whether data analysis on the bioelectric signal extracted in step 412 is valid. If the data analysis on the bioelectric signal extracted in step 412 is valid as a result of the determination, the procedure proceeds to step 418, where a specific waveform is extracted from the extracted bioelectric signal. In contrast, if the data analysis on the extracted bioelectric signal is not valid as a result of the determination in step 414, the procedure proceeds to step 416, where a guide line for leading the user to again touch the touchscreen is provided.

Thereafter, the extracted specific waveform is compared with a pre-registered specific waveform in step 420, and the extracted specific waveform is within a preset similar range of the pre-registered specific waveform in step 422. When the extracted specific waveform is not within the preset similar range, it the extracted specific waveform is different from that of the ID registered in the mobile terminal, so that the ID authentication performance for the corresponding user is terminated. In contrast, when the extracted specific waveform is within the preset similar range, the corresponding user is recognized as an authorized user, so that the use lock mode of the mobile terminal is released in step 424.

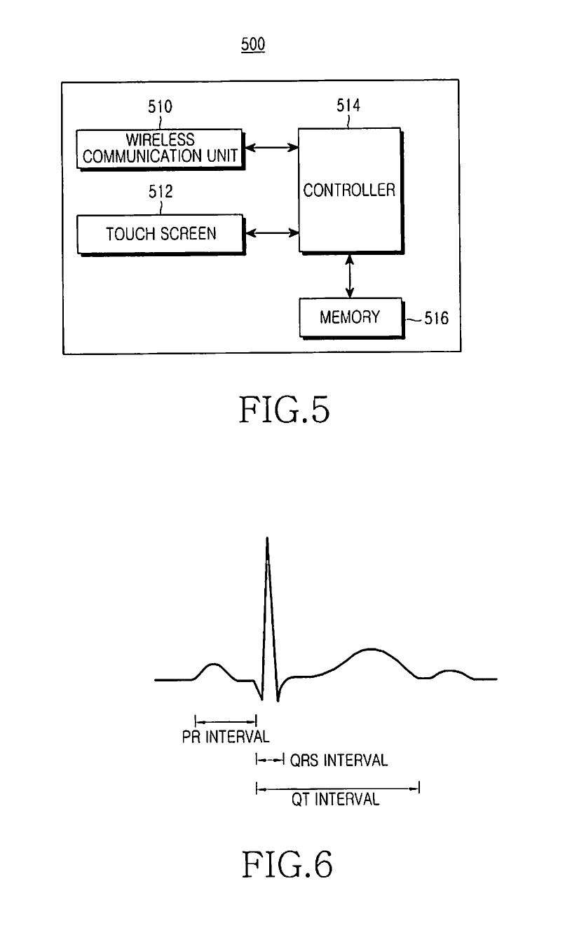

FIG. 5 is a block diagram illustrating the configuration of an ID recognition apparatus in a mobile terminal having a touchscreen according to an embodiment of the present invention. Although FIG. 5 shows an example of a mobile terminal 500, to which the present invention is applied, which includes includes a wireless communication unit 510, a touchscreen 512, a controller 514, and a memory 516, the mobile terminal 500 may further include a camera, a speaker, a microphone, and the like in addition to the shown components.

The wireless communication unit 510 receives a wireless downlink signal using an antenna and outputs downlink data obtained through demodulation of the wireless downlink signal to the controller 514. Also, the wireless communication unit 510 modulates uplink data input from the controller 514 to generate a wireless uplink signal and wirelessly transmits the generated wireless uplink signal to the air using the antenna. Such modulation and demodulation can be preferably performed in a Code Division Multiple Access (CDMA) scheme, as well as in a Frequency Division Multiplexing (FDM) scheme, a Time Division Multiplexing (TDM) scheme, or the like.

The memory 516 stores images for providing various functions of applications and the related Graphical User Interface (GUI), databases relevant to user information and documents, background images (for example, a menu screen and a standby screen) and/or operating programs necessary for driving the mobile terminal 500, etc.

Also, according to an embodiment of the present invention, in order to perform ID recognition, a specific part is extracted from a bioelectric signal of the user of the mobile terminal, the extracted specific part is stored as a specific waveform corresponding to the ID of the user.

The touchscreen 512 generates an interrupt caused by a user's touch, includes an Electrocardiogram (EKG) sensor for sensing an EKG electric signal of the user, and outputs a bioelectric signal sensed by the EKG sensor to the controller 514.

The controller 514 determines whether data analysis on a bioelectric signal, which is caused by the touch of a user and is input from the touchscreen 512, is valid based on an input of a mode selection signal. When data analysis on the bioelectric signal is valid, the controller 514 performs a control operation to extract a specific waveform from an extracted electric signal, and to register the extracted specific waveform as the user's ID.

Also, the controller 514 receives a bioelectric signal, which is caused by a user's touch and is input from the touchscreen 512, and determines whether data analysis on the bioelectric signal is valid according to an input mode selection signal. When the data analysis on the bioelectric signal is valid, the controller 512 extracts a specific waveform from an extracted electric signal, compares the extracted specific waveform with a pre-registered specific waveform, and controls the mobile terminal to release the use lock mode when the extracted specific waveform is included within a preset similar range.

The ID recognition method and apparatus in a mobile terminal having a touchscreen according to an embodiment of the present invention may be implemented as above. While the invention has been shown and described with reference to certain embodiments thereof, it will be understood by those skilled in the art that various changes in form and details may be made therein without departing from the spirit and scope of the invention as defined by the appended claims. Accordingly, the scope of the invention is not to be limited by the above embodiments but by the appended claims and equivalents thereof.

As described above, according to the present invention, a bioelectric signal is measured through the use of a mobile terminal having a touchscreen, and a specific waveform extracted from the bioelectric signal is set as an ID, so that a unique ID for the user can be set, and a bioelectric signal can be measured and shown on the screen, which is implemented with a touchscreen, thereby enabling visualization of a measured value.

What is claimed is:

1. A method for recognizing an Identification (ID) in a mobile terminal having a touchscreen, the method comprising the steps of:
activating the touchscreen of the mobile terminal and receiving a selection of either an ID registration mode or an ID authentication mode from a user;
extracting a first bioelectric signal which is caused by the touch of the user and is input from the touchscreen when the ID registration mode is selected;
performing a data analysis on the extracted first bioelectric signal;
determining if the data analysis on the extracted first bioelectric signal is valid;
extracting a first specific waveform from the extracted first bioelectric signal when the data analysis on the extracted first bioelectric signal is valid; and
registering the extracted first specific waveform as an ID of the user.

2. The method as claimed in claim 1, further comprising:
extracting a second bioelectric signal which is caused by a touch of a user and is input from the touchscreen when the ID authentication mode is selected;
performing a data analysis on the second bioelectric signal;
determining if the data analysis on the extracted second bioelectric signal is valid;
extracting a second specific waveform from the extracted second electric signal when the data analysis on the extracted second bioelectric signal is valid; and
comparing the extracted second specific waveform with the registered first specific waveform, and releasing a use lock mode of the mobile terminal when the extracted second specific waveform is included within a preset similar range.

3. The method as claimed in claim 1, wherein the bioelectric signal corresponds to an electrocardiogram (EKG) electric signal generated by a beating of the heart of the user.

4. The method as claimed in claim 1, further comprising providing a guide line to request that the user again attempt a touch on the touchscreen when the data analysis is invalid.

5. The method as claimed in claim 1, wherein the touch of the user is generated by a pressure of both hands of the user which is applied to a predetermined region of the touchscreen for a preset time period.

6. The method as claimed in claim 1, wherein the specific waveform is generated by an electrical potential difference of a bioelectric signal, and is different depending on the user.

7. The method as claimed in claim 5, wherein the pressure by both hands corresponds to a capacitance value output from the touchscreen.

8. An apparatus for recognizing an Identification (ID) in a mobile terminal having a touchscreen, the apparatus comprising:
a touchscreen for generating an interrupt caused by a touch of a user, the touchscreen comprising an electrocardiogram (EKG) sensor to measure a bioelectric signal; and
a controller for extracting a specific waveform from a bioelectric signal, which is caused by the touch of the user and is input from the touchscreen, according to the bioelectric signal and a mode selection signal, and then either registering the extracted specific waveform as the ID of the user, or comparing the extracted specific waveform with a pre-registered user ID and controlling the mobile terminal to release a lock mode of the mobile terminal when the extracted specific waveform is included within a preset similar range.
